(19) United States
(12) Patent Application Publication
(10) Pub. No.: US 2012/0135188 A1
(43) Pub. Date: May 31, 2012

(54) Padding construction

(76) Inventor: David V.A. Proton, Hong Kong (HK)

(21) Appl. No.: 12/927,964

(22) Filed: Nov. 29, 2010

(51) Int. Cl. D05B 23/00; B32B 3/10

(52) U.S. Cl. 428/137; 112/475.08

(57) ABSTRACT

A padding has a first outer layer that is made from an abrasion resistant fabric, a second outer layer that is made from a stretch fabric having a smooth surface, and a middle layer that is made from a foam material. The middle layer is positioned between the first and second outer layers. The first and second outer layers are then stitched along their peripheral edges to completely encapsulate the middle layer therebetween, and then a plurality of lines that are cut through all the layers.

### BACKGROUND OF THE INVENTION

1. Field of the Invention

The present invention relates to a padding construction that can be used in many applications, including use as a shock absorbing pad that is adapted for use with shock absorbing wear, such as headgear, joint guards, and bodysuits, and for use with safety devices such as personal flotation devices, among others.

2. Description of the Prior Art

Padding material is currently being used in many applications for many different purposes. One such area of use is for use with shock absorbing wear.

For shock absorbing wears, it is especially important for the pad that is adapted to be positioned adjacent to certain areas of the body (e.g., joints, the head, etc.) to be flexible, stretchable and soft enough to conform to the different sizes and shapes of such body areas on different people. However, to achieve the shock absorbing property, stronger and thicker material that is stiff and inflexible is often required.

Therefore, there remains a need for a padding construction that overcomes the drawbacks set forth above.

### SUMMARY OF THE DISCLOSURE

It is an object of the present invention to provide a padding construction that can improve the softness, stretchability and flexibility of the material, while retaining the primary properties of the material, such as shock absorption for protective wear, and buoyancy for personal flotation devices. This construction also has the added benefits of improving ventilation and reducing material waste.

Another important aspect of the present invention is that, through the use of different patterns of cut lines, the material can better conform to the different parts of the body's contour. This involves variation in angles, frequencies, shapes and lengths of the cuts.

In order to accomplish the objects of the present invention, the padding according to the present invention has a first outer layer that is made from an abrasion resistant fabric, a second outer layer that is made from a stretch fabric having a smooth surface, and a middle layer that is made from a foam material. The middle layer is positioned between the first and second outer layers. The first and second outer layers are then stitched along their peripheral edges to completely encapsulate the middle layer therebetween, and then a plurality of lines that are cut through all the layers.

### BRIEF DESCRIPTION OF THE DRAWINGS

FIG. 1 is an exploded perspective view illustrating the layers that make up a piece of padding according to one embodiment of the present invention.

FIG. 2 is a perspective view of the padding of FIG. 1 after lamination of the layers.

FIG. 3 is a perspective view of the padding of FIG. 1 after slits have been cut.

FIG. 4 is a perspective view of the padding of FIG. 1 after the layers have been stitched together.

FIGS. 5A and 5B illustrate the front and the rear, respectively, of a bodysuit that includes the padding of FIGS. 1-4 in use at certain locations.

FIGS. 6A-6C illustrate the different configurations of the padding in the relaxed, slightly stretched, and fully stretched states, respectively.

FIG. 7A illustrates a pattern that can be used for the lines for use with a shock absorbing helmet.

FIG. 7B illustrates the lines of FIG. 7A as applied to a shock absorbing helmet.

FIG. 8A illustrates a pattern that can be used for the lines for use with a knee sleeve.

FIG. 8B illustrates the lines of FIG. 8A as applied to a knee sleeve.

FIG. 9A illustrates a pattern that can be used for the lines for use on the back of a personal flotation device.

FIG. 9B illustrates the lines of FIG. 9A as applied to the back of a personal flotation device.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

Referring to FIG. 1, the padding 20 according to the present invention is made up of three layers, a first outer layer 22, a middle layer 24 and a second outer layer 26. The first outer layer 22 is preferably an abrasion resistant fabric, and a non-limiting example is Material No. 02 (HL-987) made by Hong Li Textile Co., Ltd, which comprises 79% Nylon, 15% Kevlar™, and 6% Spandex™. The middle layer 24 is a foam material, and non-limiting examples include a yellow foam 5 mm XRD-12197-35 made by Rogers Corporation, and PVC foam. An antimicrobial finishing can be included with the middle layer 24. The second outer layer 26 is preferably a stretch fabric having a smooth touch, and a non-limiting example is Material GO90001 made by GAINMORETEX CO., LTD. Again, an antimicrobial finishing can be provided with the second outer layer 26.

The first layer 22 is usually used as an outer layer that faces away from the body of the wearer, and the second layer 26 is usually used as an inner layer that contacts the body of the wearer. As a result, it is preferable for the first layer 22 to be made of an abrasion resistant fabric, and for the second layer 26 to be made of a soft and smooth material that is comfortable to the touch for the wearer.

The following are some non-limiting dimensions for the three layers 22, 24, 26. The first layer 22 is preferably about 1 mm thick, the middle layer 24 is preferably about 4 mm thick, and the second layer 26 is preferably about 0.5 mm thick. The density of the middle layer 24 is preferably about 12 pounds per cubic feet.

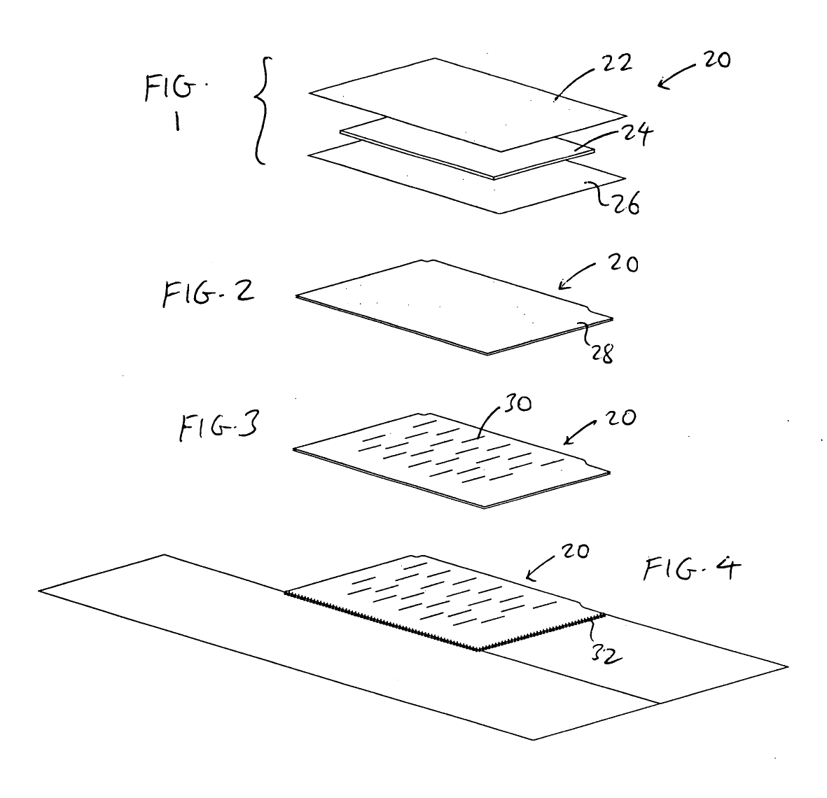

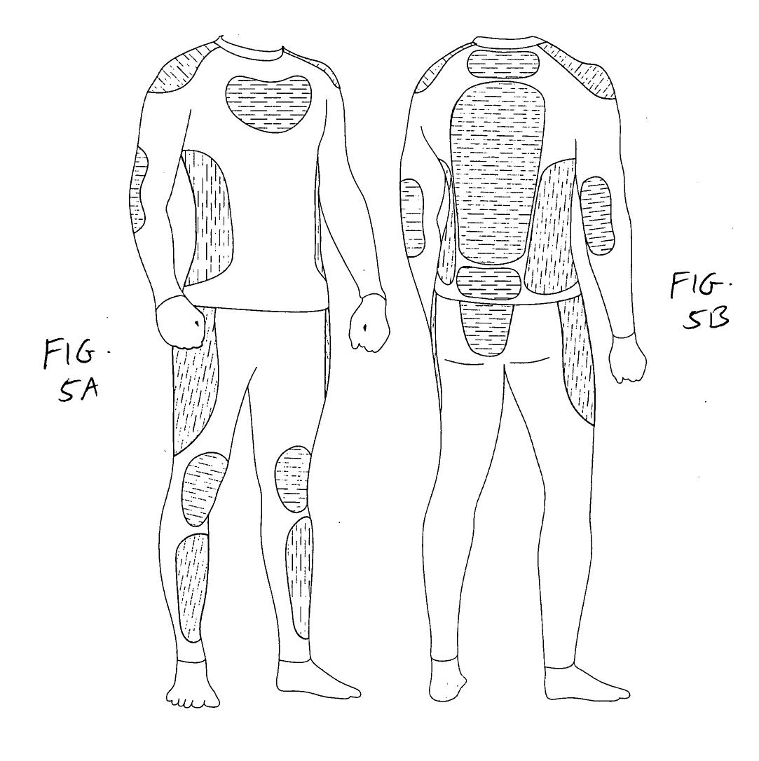

In a first step, the materials representing the padding 20 are cut into the desired shapes and sizes, with the middle layer 24 being sized slightly smaller than the outer layers 22, 24. The middle layer 24 is positioned between the outer layers 22, 26, and then the stack of layers 22, 24, 26 is laminated along the periphery of the outer layers 22, 26 so that the middle layer 24 is retained between the outer layers 22, 26 with a small border 28 of the outer layers 22, 26 extending around the periphery of the middle layer 24. See FIG. 2.

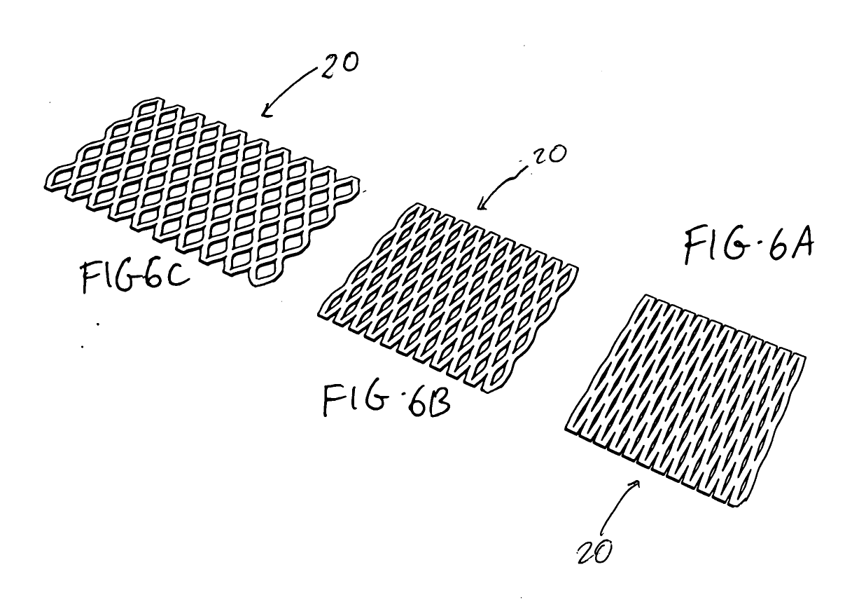

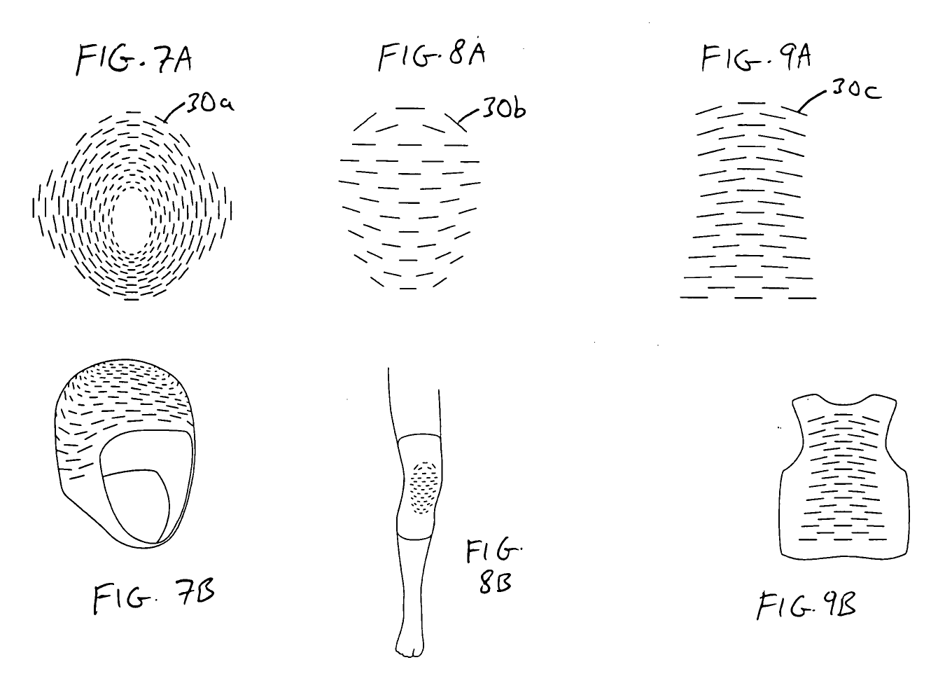

Next, lines 30 are cut on the assembled padding 20 through all three layers 22, 24, 26. See FIG. 3. As described in greater detail below in connection with FIGS. 7-9, these lines 30 can be cut in different patterns, directions and sizes depending on their application or use. The cutting can be accomplished by using a die-cut mold that has many blades for cutting through the three layers 22, 24, 26. The blades are designed to be very thin so that the cut itself will not remove any parts from the three layers 22, 24, 26. For example, FIG. 6A shows the final construction of the padding 20 in its normal relaxed state, FIG. 6B shows the padding 20 slightly stretched or expanded, and FIG. 6C shows the padding 20 fully expanded.

Finally, a stitching 32 is applied to the peripheral edges of the padding 20. The completed padding 20 is now ready to be used with any desired item. The padding 20 can be used with shock absorbing wear, shock absorbing cases or containers, personal floatation devices, wetsuits, and helmets.

For example, FIGS. 5A and 5B illustrate a bodysuit (which can be a wetsuit) which has the padding 20 positioned at locations of joints, such as the shoulder, elbow and knee, and at locations such as the chest, the sides, along the spine, and even the head. The padding 20 provides stretchability and breathability at important locations.

FIGS. 7A-9B illustrate different patterns for the lines 30 as used with different applications. For example, FIG. 7A illustrates the lines 30a for use with a shock absorbing helmet. The lines 30a are arranged in a concentric manner in a circular pattern to cover the skull portion of an individual, with the length of the lines being smaller near the middle and greater near the outside.

FIG. 8A illustrates the lines 30b for use with a knee sleeve. The lines 30b are generally horizontally-oriented, with the totality of the lines 30b forming an oval to cover the knee.

FIG. 9A illustrates the lines 30c for use with the back of a personal flotation device. The lines 30c are generally horizontally-oriented, with alternating rows of lines 30c having different numbers of lines 30c on alternating rows.

The spacing between the lines 30 can be varied. For example, the spacing between the lines 30a in FIG. 7A is tighter or smaller than the spacing between the lines 30b in FIG. 8A.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A padding, comprising:
a first outer layer that is made from an abrasion resistant fabric;
a second outer layer that is made from a stretch fabric having a smooth surface;
a middle layer that is made from a foam material, the middle layer positioned between the first and second outer layers, the first and second outer layers having a peripheral edge, and with the first and second outer layers stitched along their peripheral edges to completely encapsulate the middle layer therebetween; and
wherein a plurality of lines that are cut through all the layers.

2. The padding of claim 1, wherein the first outer layer comprises 79% Nylon, 15% Kevlar™, and 6% Spandex™.

3. The padding of claim 1, wherein the middle layer is made of Neoprene™.

4. The padding of claim 1, wherein the middle layer includes an antimicrobial finishing.

5. The padding of claim 5, wherein the second outer layer includes an antimicrobial finishing.

6. The padding of claim 1, wherein the plurality of lines are arranged in a concentric manner in a circular pattern, with the length of the lines being smaller near the middle and greater near the outside.

7. The padding of claim 1, wherein the plurality of lines are generally horizontally-oriented, with the totality of the lines forming an oval shape.

8. The padding of claim 1, wherein the plurality of lines are generally horizontally-oriented, with alternating rows of lines having different numbers of lines on alternating rows.

9. A method making a padding, comprising:
providing a first outer layer that is made from an abrasion resistant fabric;
providing a second outer layer that is made from a stretch fabric having a smooth surface;
providing a middle layer that is made from a foam material;
positioning the middle layer positioned between the first and second outer layers;
cutting a plurality of lines through all the layers; and
stitching the peripheral edges of the first and second outer layers to completely encapsulate the middle layer therebetween.

10. The method of claim 9, further including providing the first outer layer in a material that comprises 79% Nylon, 15% Kevlar™, and 6% Spandex™.

11. The method of claim 9, further including providing the middle layer in the form of Neoprene™.

12. The method of claim 9, further including providing the middle layer with an antimicrobial finishing.

13. The method of claim 12, further including providing the second outer layer with an antimicrobial finishing.

14. The method of claim 9, further including arranging the plurality of lines in a concentric manner in a circular pattern, with the length of the lines being smaller near the middle and greater near the outside.

15. The method of claim 9, further including arranging the plurality of lines in a horizontally-oriented manner, with the totality of the lines forming an oval shape.

16. The method of claim 9, further including arranging the plurality of lines in a horizontally-oriented manner, with alternating rows of lines having different numbers of lines on alternating rows.
